(19) United States
(12) Patent Application Publication
(10) Pub. No.: US 2025/0080382 A1
(43) Pub. Date: Mar. 6, 2025

(54) SYSTEMS AND METHODS OF BEAMFORMING SOUNDING FOR ARTIFICIAL REALITY APPLICATIONS

(71) Applicant: Meta Platforms Technologies, LLC, Menlo Park, CA (US)

(72) Inventors: Carlos Horacio Aldana, Mountain View, CA (US); Muhammad Kumail Haider, Sunnyvale, CA (US)

(73) Assignee: Meta Platforms Technologies, LLC, Menlo Park, CA (US)

(21) Appl. No.: 18/622,462

(22) Filed: Mar. 29, 2024

Related U.S. Application Data
(60) Provisional application No. 63/536,308, filed on Sep. 1, 2023.

(51) Int. Cl. H04L 25/02; H04B 7/06; H04W 84/12

(52) U.S. Cl. CPC H04L 25/0224; H04B 7/0617; H04B 7/0632; H04W 84/12

(57) ABSTRACT

A first device includes one or more processors configured to determine a frequency of channel sounding based at least on a movement characteristic of the first device. The one or more processors can generate a first frame requesting a second device in a wireless local area network (WLAN) to perform channel sounding with the first device using the determined frequency of channel sounding. The one or more processors can wirelessly transmit, via a transceiver, the generated first frame to the second device.

### CROSS-REFERENCE TO RELATED APPLICATION

This application claims priority to U.S. Provisional Patent Application No. 63/536,308 filed on Sep. 1, 2023, which is incorporated by reference herein in its entirety for all purposes.

### FIELD OF DISCLOSURE

The present disclosure is generally related to beamforming sounding (or channel sounding) for artificial reality applications and/or for body area network (BAN), including but not limited to systems and methods for signaling information on a frequency of beamforming sounding (or channel sounding) between a beamformer device (Bfer) and a beamformee device (Bfee).

### BACKGROUND

Artificial reality such as a virtual reality (VR), an augmented reality (AR), a mixed reality (MR), or an extended reality (XR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a first device (e.g., a beamformee, such as a non-AP STA or an AP) including one or more processors configured to determine a frequency of channel sounding based at least on a movement characteristic of the first device, generate a first frame (e.g., CB/CQI frame, management, or a new action frame) requesting a second device (E.g., a beamformer, such as a non-AP STA or an AP) in a wireless local area network (WLAN) to perform channel sounding with the first device using the determined frequency of channel sounding, and wirelessly transmit, via a transceiver, the generated first frame to the second device.

In some embodiments, one of the first device or the second device is an access point. In some embodiments, the one or more processors are further configured to set a field of the first frame to a first value (E.g., set beamformee channel sounding profile field to a value indicating 0 m/s) indicating one or more velocities of the first device, to request the second device to perform channel sounding with the first device periodically according to the one or more velocities. In some embodiments, the one or more processors are configured to set the field of the first frame (e.g., a value indicating 0 m/s implies period of every 100 ms while a value indicating 1-2 m/s implies period of every 50 ms) to indicate a first velocity greater than a second velocity to request the second device to perform channel sounding with the first device periodically using a first period smaller than a second period that is used by the second device in performing channel sounding when requested by setting the field of the first frame to indicate the second velocity. In some embodiments, the one or more processors are further configured to set the field of the first frame to a second value (e.g., set beamformee channel sounding profile field to a value indicating >2 m/s to imply sounding before every beamforming frame) different from the first value, to request the second device to perform channel sounding with the first device and subsequently send a beamformed frame to the first device.

In some embodiments, the one or more processors are further configured to set a subfield of the first frame to a value indicating a range of channel sounding periods (E.g., set beamformee channel sounding profile field to a value indicating >10 ms period range), to request the second device to perform channel sounding with the first device periodically using a period in the range of channel sounding periods. In some embodiments, the one or more processors are further configured to receive, from the second device, a second frame (e.g., a frame sent by a beamformer which specifies a minimum period of channel sounding) including a field indicating a minimum period of channel sounding used by the second device, and determine the period of channel sounding based at least on the minimum period of channel sounding and the movement characteristic of the first device.

In some embodiments, the first frame is a frame having a type of an action frame, and the first frame includes a field of extremely high throughput (EHT) action indicating compressed beamforming (CB)/channel quality indication (CQI). In some embodiments, the first frame is one of an association request frame, an association response frame, a probe request frame, or a probe response frame. In some embodiments, the first frame is a frame having a type of an action frame, and the first frame includes a field of extremely high throughput (EHT) action indicating beamformee sounding profile.

Various embodiments disclosed herein are related to a method. The method includes determining, by a first device, a frequency of channel sounding based at least on a movement characteristic of the first device, generating, by the first device, a first frame requesting a second device in a wireless local area network (WLAN) to perform channel sounding with the first device using the determined frequency of channel sounding, and/or wirelessly transmitting, via a transceiver, the generated first frame to the second device.

In some embodiments, one of the first device or the second device is an access point. In some embodiments, the method includes setting a field of the first frame to a first value indicating one or more velocities of the first device, to request the second device to perform channel sounding with the first device periodically according to the one or more velocities. In some embodiments, the method includes setting the field of the first frame to indicate a first velocity greater than a second velocity to request the second device to perform channel sounding with the first device periodically using a first period smaller than a second period that is used by the second device in performing channel sounding when requested by setting the field of the first frame to indicate the second velocity. In some embodiments, the method includes setting the field of the first frame to a second value different from the first value, to request the second device to perform channel sounding with the first device and subsequently send a beamformed frame to the first device.

In some embodiments, the method includes setting a subfield of the first frame to a value indicating a range of channel sounding periods, to request the second device to perform channel sounding with the first device periodically using a period in the range of channel sounding periods. In some embodiments, the method includes receiving, from the second device, a second frame including a field indicating a minimum period of channel sounding used by the second device, and determining the period of channel sounding based at least on the minimum period of channel sounding and the movement characteristic of the first device.

In some embodiments, the first frame is a frame having a type of an action frame, and the first frame includes a field of extremely high throughput (EHT) action indicating compressed beamforming (CB)/channel quality indication (CQI). In some embodiments, the first frame is one of an association request frame, an association response frame, a probe request frame, or a probe response frame. In some embodiments, the first frame is a frame having a type of an action frame, and the first frame includes a field of extremely high throughput (EHT) action indicating beamformee sounding profile.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a block diagram of an example beamforming packet flow associated with a beamformer device and a beamformee device, according to an example implementation of the present disclosure.

FIG. 5 is an example field format for signaling information for beamforming sounding and/or channel sounding, according to an example implementation of the present disclosure.

FIG. 6A is an example field format for signaling information for beamforming sounding and/or channel sounding, according to an example implementation of the present disclosure.

FIG. 6B is an example of subfields within a field format (e.g., the field format shown in FIG. 6A) for signaling information for beamforming sounding and/or channel sounding, according to an example implementation of the present disclosure.

FIG. 7A is an example field format for signaling information for beamforming sounding and/or channel sounding, according to an example implementation of the present disclosure.

FIG. 7B is an example field format for signaling information for beamforming sounding and/or channel sounding, according to an example implementation of the present disclosure.

FIG. 8A is an example field format for signaling information for beamforming sounding and/or channel sounding, according to an example implementation of the present disclosure.

FIG. 8B is an example field format of a Bfee Channel Sounding Profile field (e.g., shown in FIG. 8A) for signaling information for beamforming sounding and/or channel sounding, according to an example implementation of the present disclosure.

FIG. 8C is an example field format of a Bfee Channel Sounding Profile field (e.g., shown in FIG. 8A) for signaling information for beamforming sounding and/or channel sounding, according to an example implementation of the present disclosure.

FIG. 8D is an example field format of a Min Bfer Sounding Period Profile (e.g., shown in FIG. 8A) for signaling information for beamforming sounding and/or channel sounding, according to an example implementation of the present disclosure.

FIG. 8E is an example field format of a Min Bfer Sounding Period Profile (e.g., shown in FIG. 8A) for signaling information for beamforming sounding and/or channel sounding, according to an example implementation of the present disclosure.

FIG. 9 is a flowchart showing an example method for signaling information for beamforming sounding and/or channel sounding, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

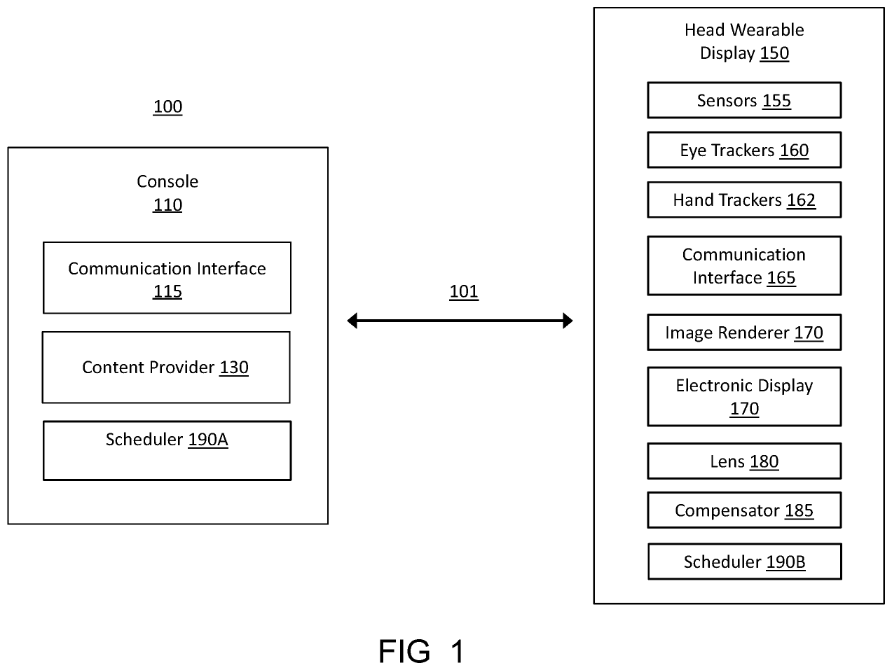

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

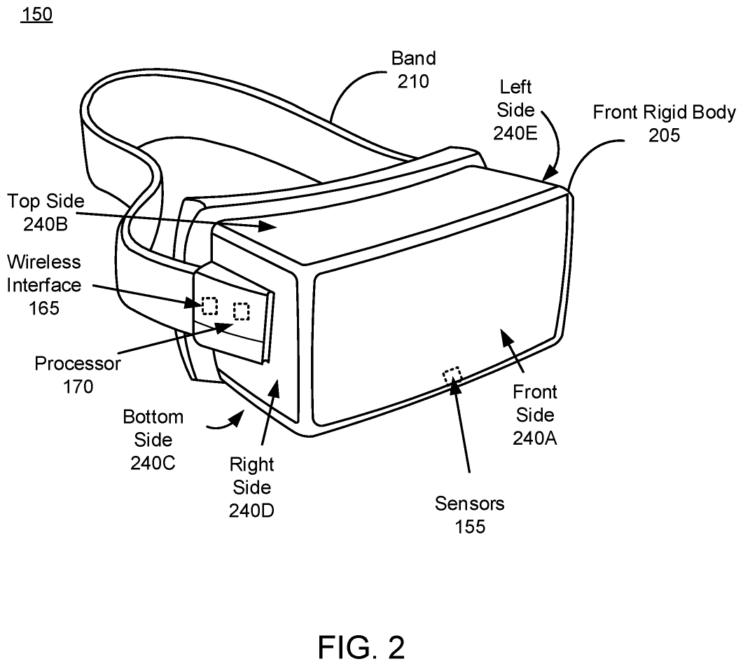

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

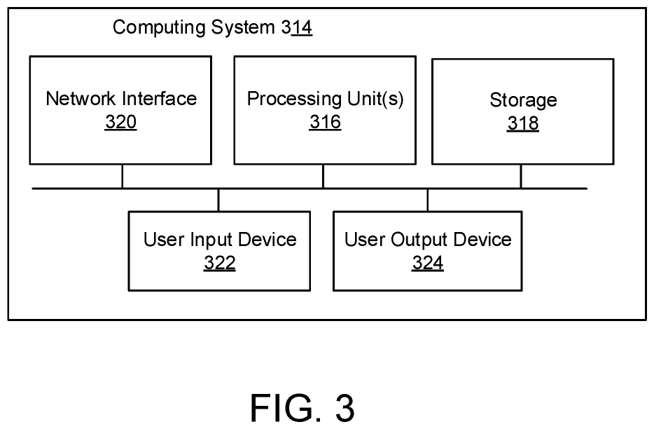

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

For indoor wireless environments, transmitter devices and receiver devices may be stationary (e.g., a laptop and an access point (AP) device), while people are moving between the devices. Currently, beamforming sounding in a wireless LAN (e.g., IEEE 802.11) is performed at very infrequent rates. For example, for single user (SU) transmissions, the beamforming sounding is performed on the order of about 100 ms (e.g., every 100 ms). For multi user (MU) transmissions, the beamforming sounding is performed on the order of about 10 ms (e.g., every 10 ms). For such transmissions (e.g., SU transmissions), it would be beneficial to perform the beamforming sounding for the channel more frequently, particularly for body area network (BAN) devices where rapid movement is expected and particularly for station devices to signal information for more frequent channel sounding. For example, for VR/XR applications, the channel should be more dynamic, and thus there is a need for beamforming for these applications.

To address this problem, embodiments of the present disclosure provide mechanisms to for signaling information on a frequency of beamforming sounding (or channel sounding) between a beamformer device (Bfer) and a beamformee device (Bfee). In some implementations, a beamforming exchange can be performed during a discovery or an association to signal channel sounding information (e.g., Bfee channel sounding information or profile). In some implementations, channel sounding information can be signaled via an action frame where a device indicates that the environment has changed and therefore a change of the speed of beamforming is requested. In some implementations, channel sounding information can be more dynamically signaled in that the beamforming frequency is indicated every time there is a channel sounding.

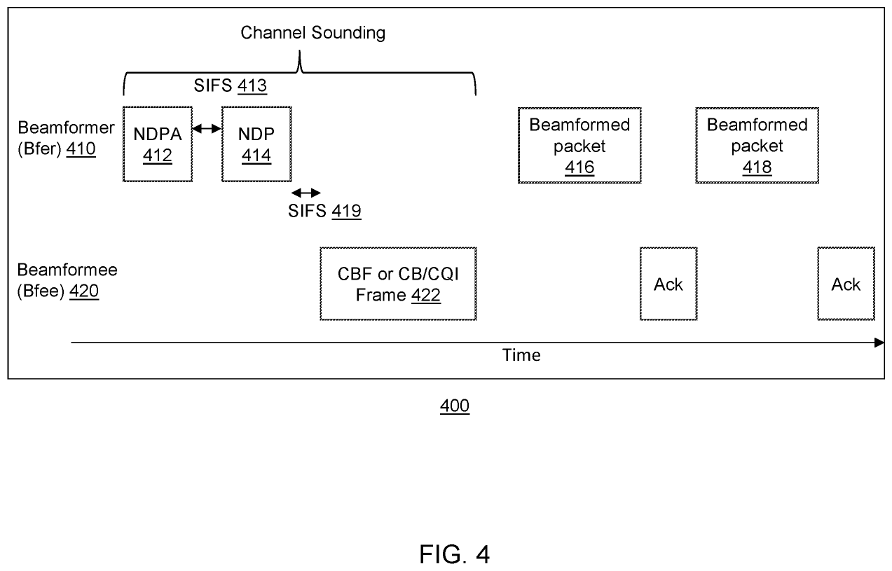

FIG. 4 is a block diagram of an example beamforming packet flow 400 associated with a beamformer device 410 and a beamformee device 420, according to an example implementation of the present disclosure. In some implementations, the beamforming packet flow 400 may be a single user (SU) beamforming packet flow. In some implementations, the beamformer device 410 may be or include an access point (AP) device or a non-AP station device. In some implementations, the beamformee device 420 may be or include an AP device or a non-AP station device.

Referring to FIG. 4, the beamformer device 410 can perform channel sounding. In some implementations, the beamformer device 410 can send a frame (e.g., Null Data Packet Announcement (NDPA) 412) to announce transmission of null data packets, and can send a frame (e.g., Null Data Packet (NDP) 414) after a short interframe space (SIFS) 413. The frame (e.g., the NDP 414) can be used for various purposes, including but not limited to, maintaining the quality of service (QOS) parameters, informing other devices (e.g., the beamformee device 420) about the availability of the channel, triggering a beamforming operation, etc.

Referring to FIG. 4, the beamformee device 420 can generate a request frame (e.g., Compressed beamforming frame (CBF) or Compressed beamforming (CB)/Channel Quality Indication (CQI) Frame 422) after a SIFS 419. In some implementations, the request frame can contain parameters to derive a beamforming matrix. In some implementations, the request frame can contain per-resource unit (RU) average signal-to-noise ratio (SNR) for each space-time stream. Based on the request frame, the beamformer device 410 can generate beamformed packets 416, 418, and the beamformee device 420 can receive the packets 416, 418 and can acknowledge the receipt.

In some implementations, the request frame can contain parameters or values to request the beamformer device 410 or any other devices (e.g., an AP device, a station device, etc.) in a wireless local area network (WLAN) to perform channel sounding with the beamformee device 420. In some implementations, the beamformee device 420 can determine a frequency of the channel sounding based at least on a movement characteristic of the beamformee device 420, and the request frame of the beamformee device 420 can contain parameters or values for the beamformer device 410 to perform the channel sounding based on the determined frequency.

The beamformee device 420 can wirelessly transmit, via a transceiver, the request frame to the beamformer device 410, in order for the beamformer device 410 to perform the channel sounding based on the determined frequency. As described herein, at least one of the beamformer device 410, the beamformee device 420, or the request frame can be configured in various manners to signal information for beamforming sounding and/or channel sounding.

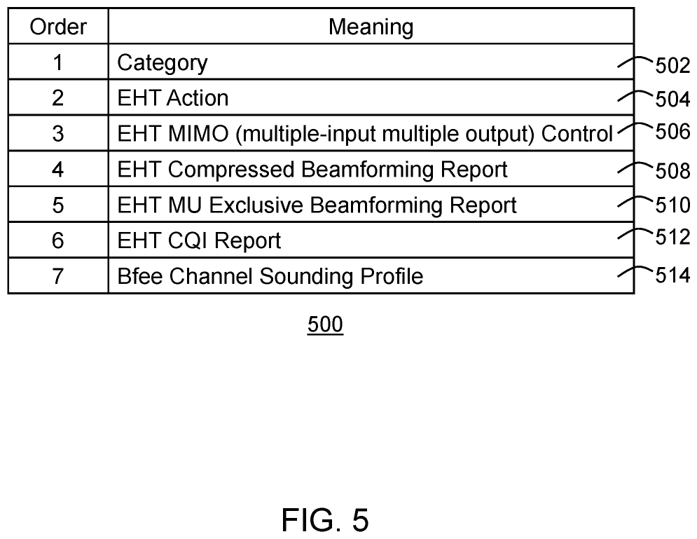

FIG. 5 is an example field format 500 for signaling information for beamforming sounding and/or channel sounding, according to an example implementation of the present disclosure. In some implementations, the field format 500 may be or included in the request frame (e.g., CBF or CB/CQI Frame 422) described above with reference to FIG. 4. In some implementations, the request frame may be or include a frame having a type of an action frame. In some implementations, the request frame may be or include a field of extremely high throughput (EHT) action indicating compressed beamforming (CB)/channel quality indication (CQI), as described below.

In some implementations, as shown in FIG. 5, the field format 500 can include fields of Category 502, EHT Action 504, EHT MIMO (multiple-input multiple output) Control 506, EHT Compressed Beamforming Report 508, EHT MU Exclusive Beamforming Report 510, EHT CQI Report 512, and Bfee Channel Sounding Profile 514. In some implementations, the presence and contents of the EHT Compressed Beamforming Report field, EHT MU Exclusive Beamforming Report field, and EHT CQI Report field may be dependent on the values of a Feedback Type subfield (not shown) of the EHT MIMO Control field.

In some implementations, information for channel sounding can be added as a new action field to the request frame (e.g., CB/CQI frame, CB/CQI frame in 802.11be, etc.). For example, as shown in FIG. 5, the field for Bfee Channel Sounding Profile 514 can be added to indicate a channel sounding profile. The Bfee Channel Sounding Profile 514 can be configured for the beamformer device 410 to perform channel sounding based on values in the Bfee Channel Sounding Profile 514.

In some implementations, the field for Bfee Channel Sounding Profile 514 can be set to a first value indicating one or more velocities of the beamformee device 420, to request the beamformer device 410 to perform channel sounding with the beamformee device 420 periodically according to the one or more velocities. For example, the field can be set to a value indicating 0 m/s. In some implementations, the field can be set to indicate a first velocity (or speed) greater than a second velocity (speed) to request the beamformer device 410 to perform channel sounding with the beamformee device 420 periodically using a first period smaller than a second period that is used by the beamformer device 410 in performing channel sounding when requested by setting the field to indicate the second velocity. For example, the value indicating a velocity of 0 m/s can imply or request the beamformer device 410 to perform channel sounding with a period of every 100 ms. For example, the value indicating a velocity of 1-2 m/s can imply or request the beamformer device 410 to perform channel sounding with a period of every 50 ms. In some implementations, the field can be set to a second value different from the first value, to request the beamformer device 410 to perform channel sounding with the beamformee device 420 and subsequently send a beamformed frame to the beamformee device 420. In some implementations, the field can be set to the second value to imply or request the beamformer device 410 to perform channel sounding before every beamforming frame. For example, the field can be set to a value indicating one or more velocities (e.g., a velocity greater than 2 m/s) to request the beamformer device 410 to perform channel sounding before every beamforming frame.

In some implementations, the request frame can be set to a value indicating a range of channel sounding periods, to request the beamformer device 410 to perform channel sounding with the beamformee device 420 periodically using a period in the range of channel sounding periods. For example, the field can be set to a value indicating a period range greater than 10 ms, and the beamformee device 420 can perform the channel sounding based on a period in the range greater than 10 ms.

In some implementations, the beamformee device 420 can receive, from the beamformer device 410, a second frame including a field indicating a minimum period of channel sounding used by the beamformer device 410. The beamformee device 420 can determine the period of channel sounding based at least on the minimum period of channel sounding and the movement characteristic of the beamformee device 420.

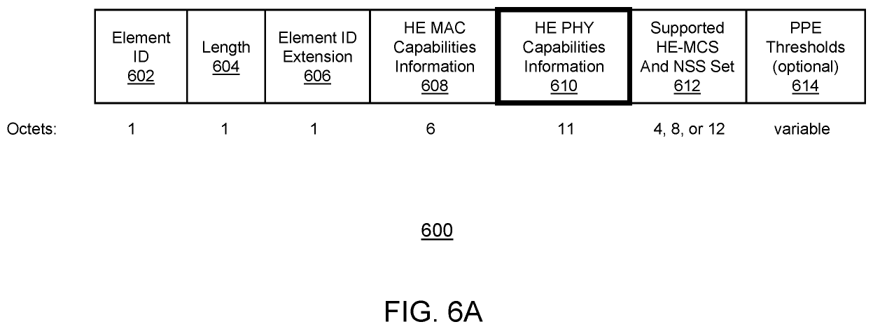

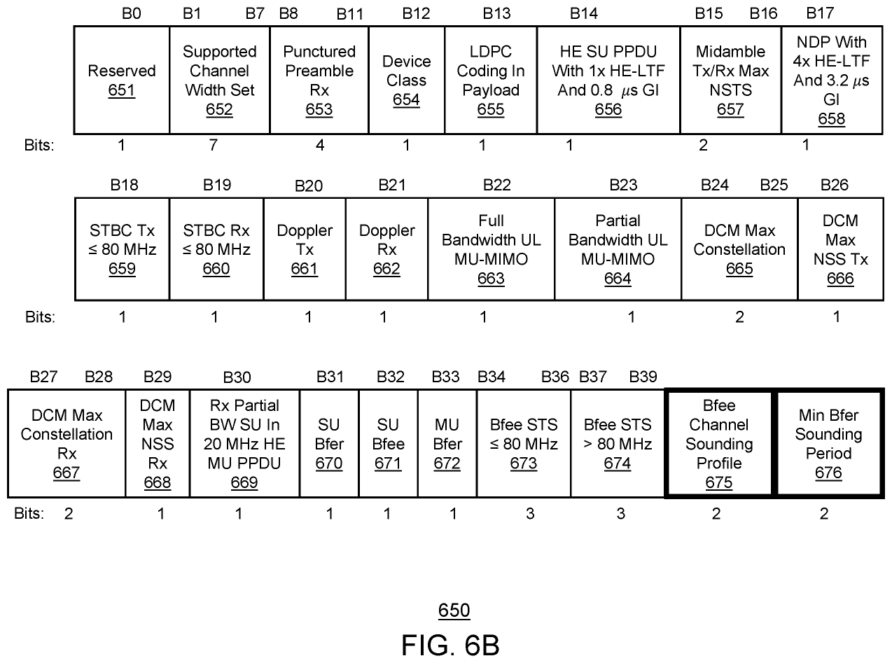

FIG. 6A is an example field format 600 for signaling information for beamforming sounding and/or channel sounding, according to an example implementation of the present disclosure. FIG. 6B is an example of subfields 650 within the field format 600 for signaling information for beamforming sounding and/or channel sounding, according to an example implementation of the present disclosure. More specifically, the field format 600 is a field format for high-efficiency (HE) physical layer (PHY) capabilities information. In some implementations, the field format 600 may be of 802.11ax capabilities field and the PHY capabilities.

As shown in FIG. 6A, the field format 600 can include fields of Element ID 602, Length 604, Element ID Extension 606, HE MAC Capabilities Information 608, HE PHY Capabilities Information 610, Supported HE_MCS And NSS Set 612, and PPE Thresholds (optional) 614. As shown in FIG. 6B, the field for HE PHY Capabilities Information 610 can include a “Reserved” field 651 and fields of Supported Channel Width Set 652, Punctured Preamble Rx 653, Device Class 654, LDPC Coding In Payload 655, HE SU PPDU With 1x HE-LTF And 0.8 μs GI 656, Midamble Tx/Rx Max NSTS 657, NDP With 4x HE-LTF And 3.2 μs GI 658, STBC Tx≤80 MHz 659, STBC Rx≤80 MHz 660, Doppler Tx 661, Doppler Rx 662, Full Bandwidth UL MU-MIMO 663, Partial Bandwidth UL MU-MIMO 664, DCM Max Constellation Tx 665, DCM Max NSS Tx 666, DCM Max Constellation Rx 667, DCM Max NSS Rx 668, Rx Partial BW SU In 20 MHz HE MU PPDU 669, SU Beamformer 670, SU Beamformee 671, MU Beamformer 672, Beamformee STS≤80 MHz 673, Beamformee STS>80 MHz 674, Beamformee (Bfee) Channel Sounding Profile 675, and Min Beamformer (Bfer) Sounding Period 676.

In some implementations, the channel sounding information can be added to a management frame. In some implementations, the management frame can be or include an association request frame, an association response frame, a probe request frame, or a probe response frame. For example, the management frame can be or include the HE PHY Capabilities Information field 610. In some implementations, the channel sounding information can be added to the HE PHY Capabilities Information field 610 during discovery and/or association (e.g., instead of sending the information every time a beamformee exchange is to occur). In some implementations, the channel sounding information can be included (and sent) in the HE PHY Capabilities Information field 610 when an association is requested, a response is made to the association, a probe is requested, a response is made to the probe request (e.g., as part of the XX capabilities field), etc.

In some implementations, the fields of Bfee Channel Sounding Profile 675 and/or Min Bfer Sounding Period 676 can be set to a first value indicating one or more velocities of the beamformee device 420, to request the beamformer device 410 to perform channel sounding with the beamformee device 420 periodically according to the one or more velocities. For example, at least one of the fields of Bfee Channel Sounding Profile 675 and/or Min Bfer Sounding Period 676 can be set to a value indicating a velocity of 0 m/s. In some implementations, at least one of the fields of Bfee Channel Sounding Profile 675 and/or Min Bfer Sounding Period 676 can be set to indicate a first velocity greater than a second velocity to request the beamformer device 410 to perform channel sounding with the beamformee device 420 periodically using a first period smaller than a second period that is used by the beamformer device 410 in performing channel sounding when requested by setting the field to indicate the second velocity. For example, the value indicating a velocity of 0 m/s can imply or request the beamformer device 410 to perform channel sounding with a period of every 100 ms. For example, the value indicating a velocity of 1-2 m/s can imply or request the beamformer device 410 to perform channel sounding with a period of every 50 ms. In some implementations, at least one of the fields of Bfee Channel Sounding Profile 675 and/or Min Bfer Sounding Period 676 can be set to a second value different from the first value, to request the beamformer device 410 to perform channel sounding with the beamformee device 420 and subsequently send a beamformed frame to the beamformee device 420. In some implementations, at least one of the fields of Bfee Channel Sounding Profile 675 and/or Min Bfer Sounding Period 676 can be set to the second value to imply or request the beamformer device 410 to perform channel sounding before every beamforming frame. For example, at least one of the fields of Bfee Channel Sounding Profile 675 and/or Min Bfer Sounding Period 676 can be set to a value indicating one or more velocities (e.g., a velocity greater than 2 m/s) to request the beamformer device 410 to perform channel sounding before every beamforming frame.

In some implementations, at least one of the fields of Bfee Channel Sounding Profile 675 and/or Min Bfer Sounding Period 676 can be set to a value indicating a range of channel sounding periods, to request the beamformer device 410 to perform channel sounding with the beamformee device 420 periodically using a period in the range of channel sounding periods. For example, at least one of the fields of Bfee Channel Sounding Profile 675 and/or Min Bfer Sounding Period 676 can be set to a value indicating a period range greater than 10 ms, and the beamformee device 420 can perform the channel sounding based on a period in the range greater than 10 ms.

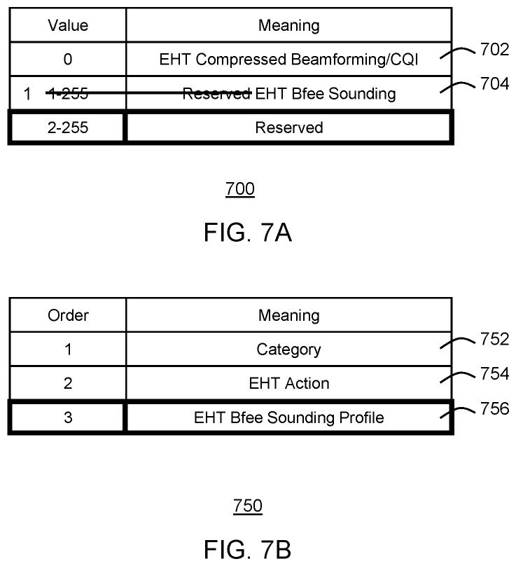

FIG. 7A is an example field format 700 for signaling information for beamforming sounding and/or channel sounding, according to an example implementation of the present disclosure. The field format 700 can include fields of EHT Compressed Beamforming/CQI 702 and “Reserved” 704. In some implementations, as shown in FIG. 7A, at least one of the “Reserved” fields can be configured as a new action field (e.g., hereinafter referred to as EHT Bfee Sounding 704) and/or can be of a frame having a type of an action frame. As described below, the EHT Bfee Sounding field 704 can be used for the beamformee device 420 to request the beamformer device 410 to perform channel sounding with the beamformee device 420.

FIG. 7B is an example field format 750 for signaling information for beamforming sounding and/or channel sounding, according to an example implementation of the present disclosure. The field format 750 can include fields of Category 752, EHT Action 754, and EHT Bfee Sounding Profile 756. In some implementations, as shown in FIG. 7B, the EHT Bfee Sounding Profile field 756 can be added as a new action field. As described below, the EHT Bfee Sounding Profile field 756 can be used for the beamformee device 420 to request the beamformer device 410 to perform channel sounding with the beamformee device 420.

In some implementations, the channel sounding information (e.g., sounding profile information) may be changed after association (e.g., instead of sending the sounding profile information at every beamforming instance). Here, the EHT Bfee Sounding field 704 can be configured (e.g., from the Reserved field) and/or the EHT Bfee Sounding Profile 756 can be added to change/update the sounding profile after the association (e.g., instead of being carried in a beamforming report).

In some implementations, the fields of EHT Bfee Sounding field 704 and/or EHT Bfee Sounding Profile 756 can be set to a first value indicating one or more velocities of the beamformee device 420, to request the beamformer device 410 to perform channel sounding with the beamformee device 420 periodically according to the one or more velocities. For example, at least one of the fields of EHT Bfee Sounding field 704 and/or EHT Bfee Sounding Profile 756 can be set to a value indicating a velocity of 0 m/s. In some implementations, at least one of the fields of EHT Bfee Sounding field 704 and/or EHT Bfee Sounding Profile 756 can be set to indicate a first velocity greater than a second velocity to request the beamformer device 410 to perform channel sounding with the beamformee device 420 periodically using a first period smaller than a second period that is used by the beamformer device 410 in performing channel sounding when requested by setting the field to indicate the second velocity. For example, the value indicating a velocity of 0 m/s can imply or request the beamformer device 410 to perform channel sounding with a period of every 100 ms. For example, the value indicating a velocity of 1-2 m/s can imply or request the beamformer device 410 to perform channel sounding with a period of every 50 ms. In some implementations, at least one of the fields of EHT Bfee Sounding field 704 and/or EHT Bfee Sounding Profile 756 can be set to a second value different from the first value, to request the beamformer device 410 to perform channel sounding with the beamformee device 420 and subsequently send a beamformed frame to the beamformee device 420. In some implementations, at least one of the fields of EHT Bfee Sounding field 704 and/or EHT Bfee Sounding Profile 756 can be set to the second value to imply or request the beamformer device 410 to perform channel sounding before every beamforming frame. For example, at least one of the fields of EHT Bfee Sounding field 704 and/or EHT Bfee Sounding Profile 756 can be set to a value indicating one or more velocities (e.g., a velocity greater than 2 m/s) to request the beamformer device 410 to perform channel sounding before every beamforming frame.

In some implementations, at least one of the fields of EHT Bfee Sounding field 704 and/or EHT Bfee Sounding Profile 756 can be set to a value indicating a range of channel sounding periods, to request the beamformer device 410 to perform channel sounding with the beamformee device 420 periodically using a period in the range of channel sounding periods. For example, at least one of the fields of EHT Bfee Sounding field 704 and/or EHT Bfee Sounding Profile 756 can be set to a value indicating a period range greater than 10 ms, and the beamformee device 420 can perform the channel sounding based on a period in the range greater than 10 ms.

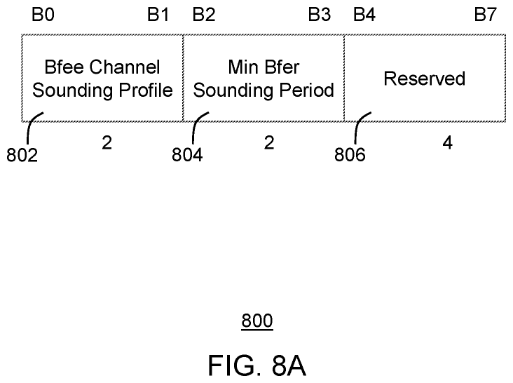

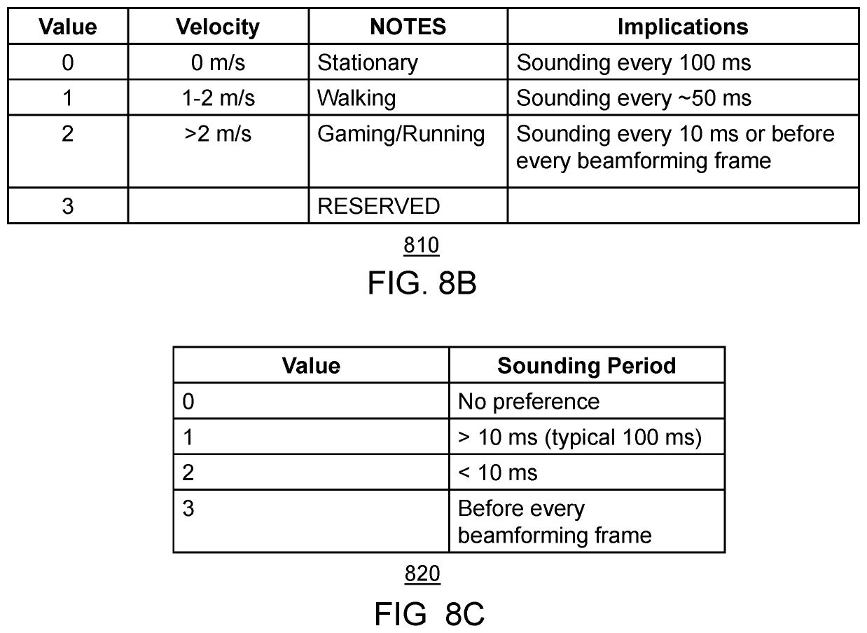

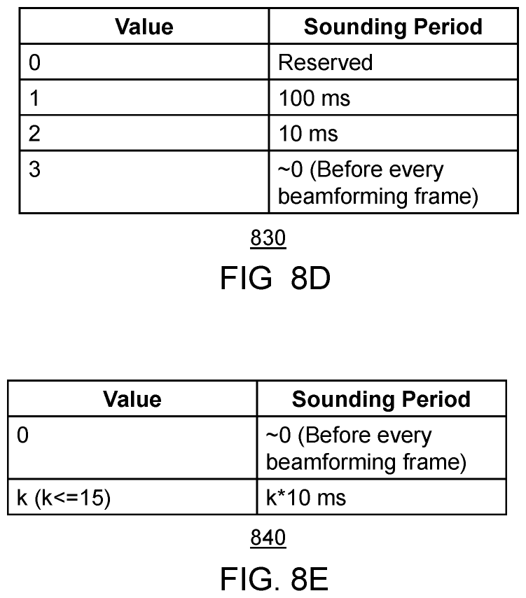

FIG. 8A is an example field format 800 for signaling information for beamforming sounding and/or channel sounding, according to an example implementation of the present disclosure. More specifically, the field format 800 can be or included in the EHT Bfee Sounding Profile field 704 and/or the EHT Bfee Sounding Profile field 756. As shown in FIG. 8A, the fields of the field format 800 can include subfields of Bfee Channel Sounding Profile 802, Min Bfer Sounding Period 804, and Reserved 806, which are described in greater detail below with respect to FIG. 8B to 8E.

FIG. 8B is an example field format 810 of the Bfee Channel Sounding Profile field 802 for signaling information for beamforming sounding and/or channel sounding, according to an example implementation of the present disclosure. As shown in the field format 810, a value of the Bfee Channel Sounding Profile field 802 can be set to “0,” “1,” “2,” or “3” to indicate a velocity of the device (e.g., the beamformee device 420) and imply or request channel sounding. In some implementations, the value set to “0” can indicate a velocity of 0 m/s (e.g., the device is stationary) and can imply or request channel sounding about every 100 m/s. In some implementations, the value set to “1” can indicate a velocity of 1-2 m/s (e.g., the device is moving at a walking velocity) and can imply or request channel sounding about every 50 m/s. In some implementations, the value set to “2” can indicate a velocity greater than 2 m/s (e.g., the device is being used for gaming/running, etc.) and can imply or request channel sounding about every 10 ms or before every beamforming frame. In some implementations, a value “3” can be reserved (e.g., to be further configured for various purposes).

FIG. 8C is an example field format 820 of the Bfee Channel Sounding Profile field 802 for signaling information for beamforming sounding and/or channel sounding, according to an example implementation of the present disclosure. As shown in the field format 820, a value of the Bfee Channel Sounding Profile field 802 can be set to “0,” “1,” “2,” or “3” to indicate a sounding period. In some implementations, the value set to “0” can indicate no preference for the sounding period, and the sounding period can be further configured with other values or can be set without any value. In some implementations, the value set to “1” can indicate the sounding period to be set with a period greater than 10 ms (e.g., 100 ms). In some implementations, the value set to “2” can indicate the sounding period to be set with a period smaller than 10 ms. In some implementations, the value set to “3” can indicate that the channel sounding is to be performed before every beamforming frame.

FIG. 8D is an example field format 830 of the Min Bfer Sounding Period 804 for signaling information for beamforming sounding and/or channel sounding, according to an example implementation of the present disclosure. As shown in the field format 830, a value of the Min Bfer Sounding Period field 804 can be set to “0,” “1,” “2,” or “3” to indicate a minimum sounding period. In some implementations, a value “0” can be reserved (e.g., to be further configured for various purposes). In some implementations, the value set to “1” can indicate the minimum sounding period to be set with about 100 ms. In some implementations, the value set to “2” can indicate the minimum sounding period to be set with about 10 ms. In some implementations, the value set to “3” can indicate the minimum sounding period to be set with about 0 ms (e.g., the sounding is to be performed before every beamforming frame.).

FIG. 8E is an example field format 840 of the Min Bfer Sounding Period 804 for signaling information for beamforming sounding and/or channel sounding, according to an example implementation of the present disclosure. As shown in the field format 840, a value of the Min Bfer Sounding Period field 804 can be set to “0” or “k” (e.g., k≤15) to indicate a minimum sounding period. In some implementations, the value set to “0” can indicate the minimum sounding period to be set with about 0 ms (e.g., the sounding is to be performed before every beamforming frame.). In some implementations, the value set to “k” can indicate the minimum sounding period to be set as a function of k. For example, the function may be k×(10 ms), which can be set to the minimum sounding period based on the value of k.

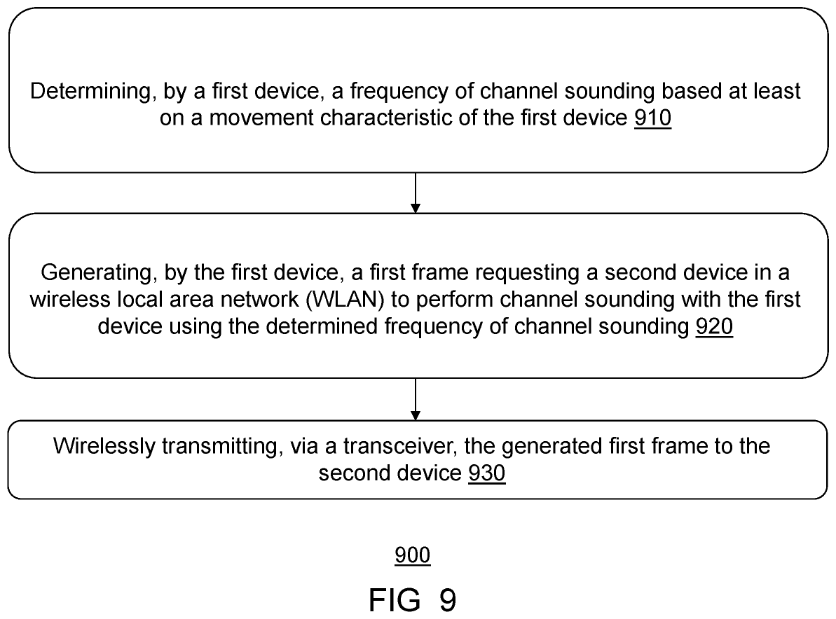

FIG. 9 is a flowchart showing an example method 900 for signaling information for beamforming sounding and/or channel sounding, according to an example implementation of the present disclosure. In some implementations, the method 900 can be performed by a device (e.g., the Beamformee device 420). In some embodiments, the method 900 may be performed by other entities. In some embodiments, the method 900 includes more, fewer, or different steps than shown in FIG. 9.

The method 900 can include determining, by a first device (e.g., the beamformee device 420), a frequency of channel sounding based at least on a movement characteristic of the first device (e.g., step 910 of the method 900). The method can include generating, by the first device, a first frame requesting a second device (e.g., the beamformer device 410) in a wireless local area network (WLAN) to perform channel sounding with the first device using the determined frequency of channel sounding (e.g., step 920 of the method 900). The method can include wirelessly transmitting, via a transceiver, the generated first frame to the second device (e.g., step 930 of the method 900).

In some implementations, at step 920, the method 900 can include the first device setting a field of the first frame to a first value indicating one or more velocities of the first device, to request the second device to perform channel sounding with the first device periodically according to the one or more velocities. In some implementations, the first frame is a frame (e.g., the field format 500) having a type of an action frame, and the first frame includes a field of extremely high throughput (EHT) action indicating compressed beamforming (CB)/channel quality indication (CQI). In some implementations, at step 920, the method 900 can include the first device configuring the first frame as a management frame (e.g., the field format 600) such that the first frame is one of an association request frame, an association response frame, a probe request frame, or a probe response frame. For example, the management frame can be or include a field (e.g., the HE PHY Capabilities Information field 610) for signaling information for beamforming sounding and/or channel sounding. For example, the channel sounding information can be added to the field during discovery and/or association (e.g., instead of sending the information every time a beamformee exchange is to occur). In some implementations, the channel sounding information can be included (and sent) in the field (e.g., the HE PHY Capabilities Information field 610) when an association is requested, a response is made to the association, a probe is requested, a response is made to the probe request (e.g., as part of the XX capabilities field), etc. In some implementations, at step 920, the method 900 can include the first device configuring or adding a new frame as the first frame (e.g., the field format 700, the field format 750, etc.) such that the first frame is a frame having a type of an action frame, and the first frame includes a field of extremely high throughput (EHT) action indicating beamformee sounding profile.

In some implementations, at step 920, the method 900 can include the first device receiving, from the second device, a second frame including a field indicating a minimum period of channel sounding used by the second device, and determining the period of channel sounding based at least on the minimum period of channel sounding and the movement characteristic of the first device.

In some implementations, at step 920, the method 900 can include the first device setting the field of the first frame to indicate a first velocity greater than a second velocity to request the second device to perform channel sounding with the first device periodically using a first period smaller than a second period that is used by the second device in performing channel sounding when requested by setting the field of the first frame to indicate the second velocity. For example, the value indicating a velocity of 0 m/s can imply or request the beamformer device 410 to perform channel sounding with a period of every 100 ms. For example, the value indicating a velocity of 1-2 m/s can imply or request the beamformer device 410 to perform channel sounding with a period of every 50 ms.

In some implementations, at step 920, the method 900 can include setting the field of the first frame to a second value different from the first value, to request the second device to perform channel sounding with the first device and subsequently send a beamformed frame to the first device. In some implementations, at step 920, the method 900 can setting a subfield of the first frame to a value indicating a range of channel sounding periods, to request the second device to perform channel sounding with the first device periodically using a period in the range of channel sounding periods.

Embodiments in the present disclosure have at least the following advantages and benefits. Embodiments in the present disclosure can provide useful techniques for signaling information for beamforming sounding and/or channel sounding. First, as described above, the techniques disclosed herein can improve channel sounding by performing channel sounding more frequently. This allows for dynamic and stable channel sounding, even when there is rapid movement expected. Second, as described above, the techniques disclosed herein can improve channel sounding by enabling flexible channel sounding. For example, various values (e.g., a sounding period, a minimum sounding period, etc.) can be set to configure the channel sounding, which can meet needs of various applications.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
one or more processors configured to:
determine a frequency of channel sounding based at least on a movement characteristic of the first device;
generate a first frame requesting a second device in a wireless local area network (WLAN) to perform channel sounding with the first device using the determined frequency of channel sounding; and
wirelessly transmit, via a transceiver, the generated first frame to the second device.

2. The first device according to claim 1, wherein one of the first device or the second device is an access point.

3. The first device according to claim 1, wherein the one or more processors are further configured to:
set a field of the first frame to a first value indicating one or more velocities of the first device, to request the second device to perform channel sounding with the first device periodically according to the one or more velocities.

4. The first device according to claim 3, wherein the one or more processors are configured to:
set the field of the first frame to indicate a first velocity greater than a second velocity to request the second device to perform channel sounding with the first device periodically using a first period smaller than a second period that is used by the second device in performing channel sounding when requested by setting the field of the first frame to indicate the second velocity.

5. The first device according to claim 3, wherein the one or more processors are further configured to:
set the field of the first frame to a second value different from the first value, to request the second device to perform channel sounding with the first device and subsequently send a beamformed frame to the first device.

6. The first device according to claim 1, wherein the one or more processors are further configured to:
set a subfield of the first frame to a value indicating a range of channel sounding periods, to request the second device to perform channel sounding with the first device periodically using a period in the range of channel sounding periods.

7. The first device according to claim 1, wherein the one or more processors are further configured to:
receive, from the second device, a second frame including a field indicating a minimum period of channel sounding used by the second device; and
determine the period of channel sounding based at least on the minimum period of channel sounding and the movement characteristic of the first device.

8. The first device according to claim 1, wherein
the first frame is a frame having a type of an action frame, and
the first frame comprises a field of extremely high throughput (EHT) action indicating compressed beamforming (CB)/channel quality indication (CQI).

9. The first device according to claim 1, wherein the first frame is one of an association request frame, an association response frame, a probe request frame, or a probe response frame.

10. The first device according to claim 1, wherein
the first frame is a frame having a type of an action frame, and
the first frame comprises a field of extremely high throughput (EHT) action indicating beamformee sounding profile.

11. A method comprising:
determining, by a first device, a frequency of channel sounding based at least on a movement characteristic of the first device;
generating, by the first device, a first frame requesting a second device in a wireless local area network (WLAN) to perform channel sounding with the first device using the determined frequency of channel sounding; and
wirelessly transmitting, via a transceiver, the generated first frame to the second device.

12. The method according to claim 11, wherein one of the first device or the second device is an access point.

13. The method according to claim 11, further comprising:
setting a field of the first frame to a first value indicating one or more velocities of the first device, to request the second device to perform channel sounding with the first device periodically according to the one or more velocities.

14. The method according to claim 13, further comprising:
setting the field of the first frame to indicate a first velocity greater than a second velocity to request the second device to perform channel sounding with the first device periodically using a first period smaller than a second period that is used by the second device in performing channel sounding when requested by setting the field of the first frame to indicate the second velocity.

15. The method according to claim 13, further comprising:
setting the field of the first frame to a second value different from the first value, to request the second device to perform channel sounding with the first device and subsequently send a beamformed frame to the first device.

16. The method according to claim 11, further comprising:
setting a subfield of the first frame to a value indicating a range of channel sounding periods, to request the second device to perform channel sounding with the first device periodically using a period in the range of channel sounding periods.

17. The method according to claim 11, further comprising:
receiving, from the second device, a second frame including a field indicating a minimum period of channel sounding used by the second device; and
determining the period of channel sounding based at least on the minimum period of channel sounding and the movement characteristic of the first device.

18. The method according to claim 11, wherein
the first frame is a frame having a type of an action frame, and
the first frame comprises a field of extremely high throughput (EHT) action indicating compressed beamforming (CB)/channel quality indication (CQI).

19. The method according to claim 11, wherein the first frame is one of an association request frame, an association response frame, a probe request frame, or a probe response frame.

20. The method according to claim 11, wherein
the first frame is a frame having a type of an action frame, and
the first frame comprises a field of extremely high throughput (EHT) action indicating beamformee sounding profile.
